(19) United States
(12) Patent Application Publication
(10) Pub. No.: US 2003/0034877 A1
(43) Pub. Date: Feb. 20, 2003

(54) Proximity detection for access control

(76) Inventors: Brett E. Miller, Lehi, UT (US); Kevin R. Dahl, Pleasant Grove, UT (US); Brian H. Benson, Orem, UT (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/930,023

(22) Filed: Aug. 14, 2001

(51) Int. Cl. H04Q 1/00; G05B 19/00

(52) U.S. Cl. 340/5.61; 340/5.74; 713/200

(57) ABSTRACT

Techniques for providing access control to electronic systems based on proximity detection. An authorized user of an electronic system is provided an identifier (e.g., identification badge, key fob, magnetic card) that is associated with the user's person. The identifier provides the ability for an electronic device to determine whether the identifier is within a predetermined range of the electronic device. The identifier can be, for example, a transmitter and/or receiver that transmits and/or receives wireless signals (e.g., radio frequency signals, infrared signals). The identifier can also reflect signals to the electronic device. By associating the identifier with the user's person such that the identifier provides an indication of the associated user's location, the electronic device can determine whether the user is within the predetermined region. If the user is within the predetermined region, the electronic device can take certain actions, for example, boot up or change to a secure state.

### FIELD

The invention relates to electronic systems such as computer systems. More specifically, the invention relates to use of proximity detection for access control purposes.

### BACKGROUND

Most electronic devices, for example, computer systems and copying machines, enter a low power state when not used for a predetermined period of time. The devices may be unused because a user is occupied by another activity, for example, a telephone conversation, or the device may be unused because the user as moved to a location away from the device. It is common for a user in a workplace environment to leave his/her computer and proceed to a location away from his/her computer, for example, to attend a meeting.

When the user leaves his/her computer system there is generally a period of time during which the user's computer is accessible by unauthorized users unless the user specifically shuts down the computer or activates a password-protected screen saver or other security application. Thus, during this period of time the user's computer is unsecured. Most screen saver applications that provide password protection are activated after a predetermined period of inactivity. Because a user can be engaged in using a computer system without interacting with the computer system for short periods of time, these screen saver applications may activate and require interaction by the user in order to resume normal operation. This can be frustrating to a user because the use may be reading text on a screen when the screen saver or security application locks the computer system. Thus, current commonly used security measures require positive action by a user to engage or disengage in order to avoid periods during which the device is unsecured. This results in a less than optimal use of security measures.

### BRIEF DESCRIPTION OF THE DRAWINGS

The invention is illustrated by way of example, and not by way of limitation, in the figures of the accompanying drawings in which like reference numerals refer to similar elements.

FIG. 1 is one embodiment of an electronic system.

FIG. 2 is a block diagram of a first embodiment of an electronic system and an active identifier.

FIG. 3 is a block diagram of one embodiment of an electronic system and a passive identifier.

FIG. 4 is a block diagram of a second embodiment of an electronic system and an active identifier.

### DETAILED DESCRIPTION

Techniques for providing access control to electronic systems based on proximity detection are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Techniques for providing access control to electronic systems based on proximity detection are described. An authorized user of an electronic system is provided an identifier (e.g., identification badge, key fob, magnetic card, belt buckle, watch) that is associated with the user's person. The identifier provides the ability for an electronic device to determine whether the identifier is within a predetermined region with respect to the electronic device. The identifier can be, for example, a transmitter and/or receiver that transmits and/or receives wireless signals (e.g., radio frequency signals, infrared signals, light signals). The identifier can also reflect signals to the electronic device. By associating the identifier with the user's person such that the identifier provides an indication of the associated user's location, the electronic device can determine whether the user is within the predetermined region. If the user is within the predetermined region, the electronic device can take certain actions, for example, shut down, boot up, change to a secure state.

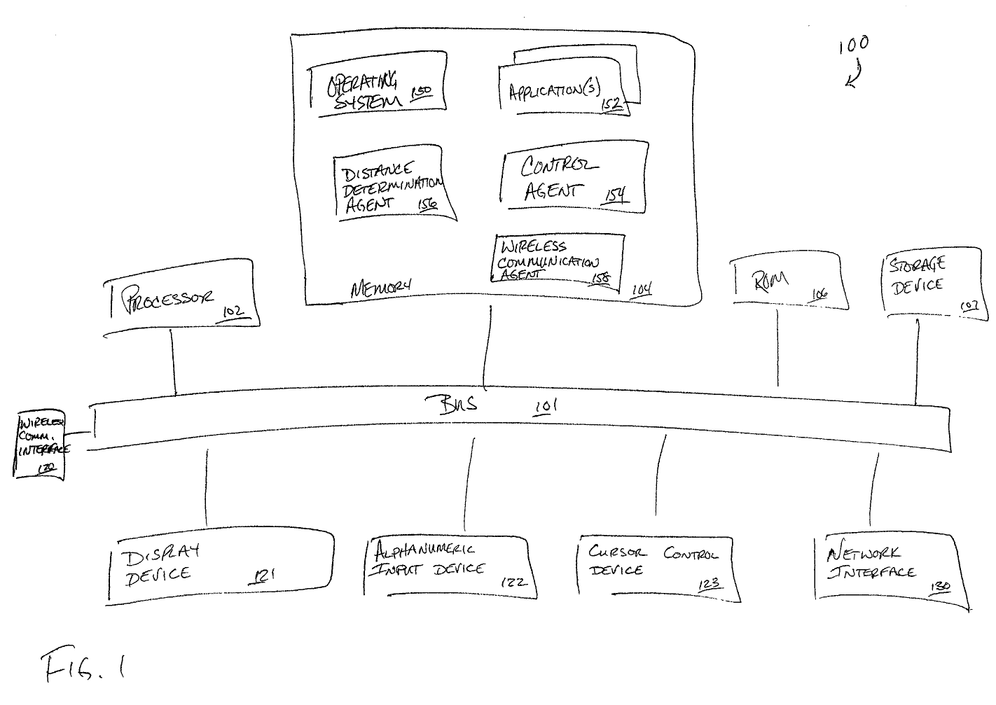

FIG. 1 is a block diagram of one embodiment of an electronic system. The electronic system illustrated in FIG. 1 is intended to represent a range of electronic systems, for example, a computer system, a kiosk, a set-top box, a teller machine, a cash register, control equipment, or any other device. Alternative computer systems can include more, fewer and/or different components.

Electronic system 100 includes bus 101 or other communication device to communicate information, and processor 102 coupled to bus 101 to process information. While electronic system 100 is illustrated with a single processor, electronic system 100 can include multiple processors and/or co-processors. Electronic system 100 further includes random access memory (RAM) or other dynamic storage device 104 (referred to as memory), coupled to bus 101 to store information and instructions to be executed by processor 102. Memory 104 also can be used to store temporary variables or other intermediate information during execution of instructions by processor 102.

Electronic system 100 also includes read only memory (ROM) and/or other static storage device 106 coupled to bus 101 to store static information and instructions for processor 102. Data storage device 107 is coupled to bus 101 to store information and instructions. Data storage device 107 such as a magnetic disk or optical disc and corresponding drive can be coupled to electronic system 100.

Electronic system 100 can also be coupled via bus 101 to display device 121, such as a cathode ray tube (CRT) or liquid crystal display (LCD), to display information to a computer user. Alphanumeric input device 122, including alphanumeric and other keys, is typically coupled to bus 101 to communicate information and command selections to processor 102. Another type of user input device is cursor control 123, such as a mouse, a trackball, or cursor direction keys to communicate direction information and command selections to processor 102 and to control cursor movement on display 121. Electronic system 100 further includes network interface 130 to provide access to a network, such as a local area network.

In one embodiment, wireless communications interface 170 is coupled to bus 101 and provides wireless communications capabilities to electronic system 100. Wireless communications interface 170 can include any combination of one or more transmitters, one or more receivers and one or more transceivers. Wireless communications interface 170 can also include relevant support components for the transmitters, receivers and/or transceivers, for example, antennae.

Instructions are provided to memory from a storage device, such as magnetic disk, a read-only memory (ROM) integrated circuit, CD-ROM, DVD, via a remote connection (e.g., over a network via network interface 130) that is either wired or wireless, etc. In alternative embodiments, hard-wired circuitry can be used in place of or in combination with software instructions to implement the present invention. Thus, the present invention is not limited to any specific combination of hardware circuitry and software instructions.

A machine-accessible medium includes any mechanism that provides (i.e., stores and/or transmits) information in a form readable by a machine (e.g., a computer). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

In one embodiment, memory 104 includes one or more of: operating system 150, application(s) 152, control agent 154, distance determination agent 156, and wireless communication agent 158. Operating system (OS) 150 controls the flow of instructions to processor 102. In one embodiment, OS 150 is the highest layer of control of electronic system 100. Memory 104 can also store one or more applications 152, which can be any type of applications and are not required to provide proximity-based access control.

Wireless communication agent 158 provides an interface between OS 150 or one of applications 152 and wireless communications interface 170. In one embodiment, wireless communication agent 158 sends signals to wireless communications interface 170 to cause wireless communications interface 170 to transmit messages according to a protocol selected by wireless communications agent 158. Wireless communications agent 158 can also process signals received via wireless communications interface 170. For example, wireless communications agent 158 can cause processor 102 to process messages received via wireless communications interface 170. Wireless communication agent 158 is illustrated as being stored in memory 104; however, wireless communication agent 158 can be implemented as any combination of hardware and software.

Control agent 154 communicates with wireless communication agent 158 in response to messages transmitted and/or received by wireless communication agent 158. In one embodiment, control agent 154 includes sequences of instructions stored in memory 104 and executed by processor 102 and/or other components. Control agent 154 interprets the messages received and/or transmitted by wireless communication agent 158. While described as being implemented by sequences of instructions, control agent 154 can be implemented as any combination of hardware and software.

Distance determination agent 156 operates with control agent 154 and/or wireless communication agent 158 to determine whether an identifier (or other predetermined device) is located within a predetermined proximity with respect to electronic system 100. Assuming a Bluetooth protocol is used by wireless communication agent 158, any receipt of a message from an identifier can be used to indicate that the identifier is within the predetermined proximity. Because Bluetooth is a low power communications protocol, messages are received by electronic system 100 only when the identifier is within a close proximity of electronic system 100.

If a higher power protocol is used, for example, HomeRF, which can be used to communicate messages over a much larger distance than Bluetooth, distance determination agent 156 is used to determine the distance between electronic system 100 and the identifier. This can be accomplished by, for example, monitoring the time between transmission of a message from electronic system 100 and receipt of a response or reflected signal from the identifier. In alternate embodiments, other techniques, for example, Global Positioning Satellite signals, triangulation, or infrared signaling, can be used to determine the distance between electronic system 100 and the identifier.

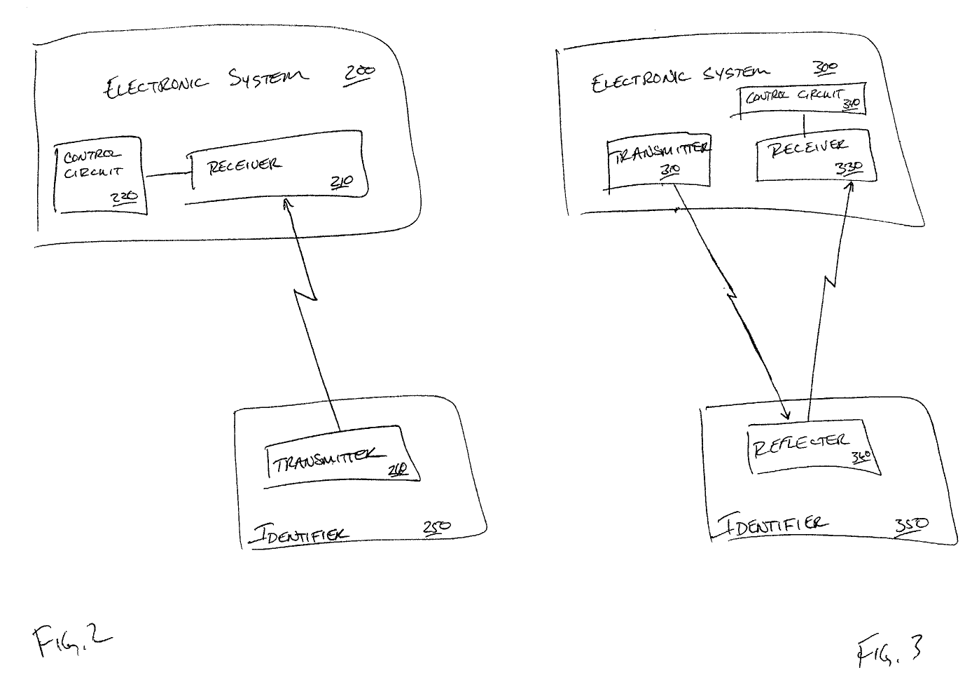

FIG. 2 is a block diagram of a first embodiment of an electronic system and an active identifier. In the embodiment of FIG. 2, electronic system 200 is intended to represent a broad class of electronic systems including, but not limited to, computer systems, set top boxes, kiosks, network access devices, automated teller machines (ATMs), security devices and biometric devices.

Electronic system 200 includes receiver 210 coupled to control circuit 220. Receiver 210 receives wireless signals from transmitter 260 that is included in identifier 250. Identifier 250 represents a device that provides an identification of a user to which the identifier is assigned. In one embodiment, identifier 250 is attached to the user such that the identifier can indicate the location of the user. In one embodiment, identifier 250 is badge that is worn by the user. In alternate embodiments, identifier 250 can be a key fob carried by the user, a watch worn by the user, or any other item that the user can carry with them.

Identifier 250 includes transmitter 260 that transmits a signal to provide identification information related to identifier 250 and therefore, the associated user. The identification information can be, for example, an employee number, a user name, a personal identification number (PIN), a user number, a group number, a group name, a position identifier (System Administrator), or any other identification information. Transmitter 260 can transmit signals according to any wireless technique (e.g., infrared, radio frequency) and using protocol (e.g., Bluetooth, IEEE 802.11b, Digital Enhanced Cordless Telecommunications (DECT)) known in the art.

Bluetooth is described in greater detail in “Specification of The Bluetooth System” v.1.0b published Dec. 1, 1999. IEEE 802.11b is described in greater detail in “Wireless LAN Medium Access Control (MAC) and Physical Layer (PHY) Specifications: Higher Speed Physical Layer (PHY) Extension in the 2.4 GHz band,” published by Institute of Electrical and Electronics Engineers (IEEE), 1999. DECT is described in greater detail in “Radio and Equipment System (RES); Digital European Cordless Telecommunications (DECT)” available from the DECT Forum of Beme, Switzerland, 1998.

In one embodiment, transmitter 260 periodically transmits a signal including the identification information, or some other indication that the user is within a predetermined proximity of electronic system 200. For example, if transmitter 260 transmits messages according to the Bluetooth standard, if receiver 210 receives a message from transmitter 260 identifier 250 can be considered within the predetermined proximity because Bluetooth provides low power transmissions.

In one embodiment, if receiver 210 does not receive a message from transmitter 260 within a predetermined period of time of a previous message, receiver 210 generates a signal to control circuit 220 indicating that identifier 250 is not within the predetermined proximity of electronic system 200. Control circuit 220 can interoperate with control agent 154 or control circuit 220 can provide sufficient functionality that control agent 154 is not necessary.

When control circuit 220 receives the signal form receiver 210 that identifier 250 is not within the predetermined proximity of electronic device 200, control system causes electronic system 200 to change states. For example, control circuit 220 can cause electronic device 200 to enter a low power state, to enter a secure state in which access is denied to unauthorized users, to enter a low power state in which access is denied to unauthorized users, or to shut down.

In one embodiment, if electronic system 200 is in a low power state, in a secure state or shut down and receiver 210 receives a signal from transmitter 260 indicating that identifier 250 is within the predetermined proximity, control circuit 220 can cause electronic system 200 to exit the low power state, exit the secure state, or boot up. Thus, control circuit 220 can cause electronic system 200 to enter an operating mode without requiring interaction from the user.

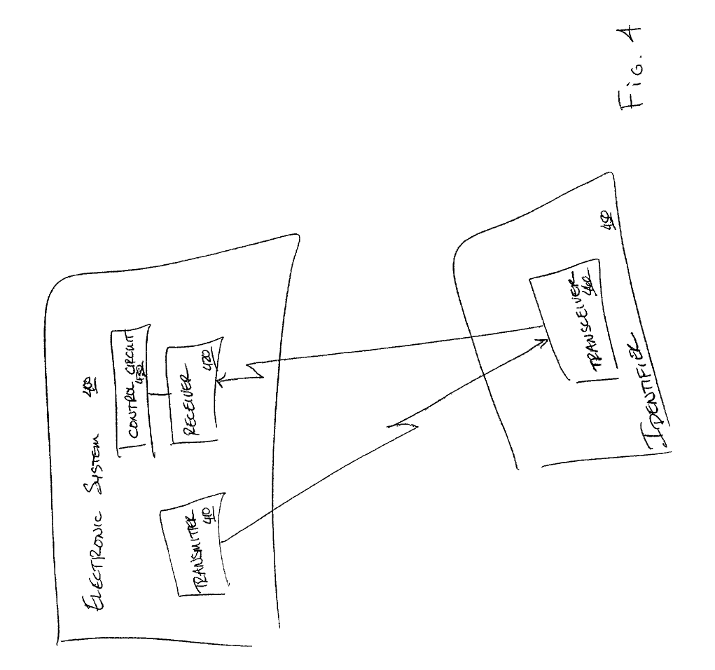

FIG. 3 is a block diagram of one embodiment of an electronic system and a passive identifier. As with electronic system 200 in FIG. 2, in the embodiment of FIG. 3, electronic system 300 is intended to represent a broad class of electronic systems. Electronic system 300 includes transmitter 310 and receiver 330 coupled to control circuit 340. Receiver 310 receives wireless signals from reflector 360 that is included in identifier 350.

Electronic system 300 includes transmitter 310 that transmits a signal to identifier 350. As described above, transmitter 310 can transmit signals according to any wireless technique and using protocol known in the art. If the identifier is within the predetermined proximity, the signal is reflected by reflector 360, which provides a uniquely modified reflected signal. The uniquely modified signal identifies identifier 350, and therefore, the associated user.

In one embodiment, transmitter 310 periodically transmits a signal. If the signal is uniquely modified and reflected by reflector 360, receiver 330 receives the reflected signal from reflector 360 and electronic system 300 remains in a normal operating state.

In one embodiment, if receiver 330 does not receive a message from transmitter 310 that has been modified by reflector 360 within a predetermined period of time of a previous message, receiver 330 generates a signal to control circuit 340 indicating that identifier 350 is not within the predetermined proximity of electronic system 300.

When control circuit 340 receives the signal form receiver 330 that identifier 350 is not within the predetermined proximity of electronic device 300, control system causes electronic system 300 to change states. For example, control circuit 340 can cause electronic device 300 to enter a low power state, to enter a secure state in which access is denied to unauthorized users, or to shut down.

In one embodiment, if electronic system 300 is in a low power state, in a secure state or shut down and receiver 330 receives a signal from transmitter 310 that has been modified and reflected by reflector 360 indicating that identifier 350 is within the predetermined proximity, control circuit 340 can cause electronic system 300 to exit the low power state, exit the secure state, or boot up. Thus, control circuit 340 can cause electronic system 300 to enter an operating mode without requiring interaction from the user.

FIG. 4 is a block diagram of a second embodiment of an electronic system and an active identifier. Electronic system 400 includes transmitter 410 and receiver 420 coupled to control circuit 430. Receiver 420 receives wireless signals from transceiver 460 that is included in identifier 450.

Transmitter 410 can transmit signals according to any wireless technique and using protocol known in the art. The signal is reflected by transceiver 460, which provides a response message in response to the message received from transmitter 410. The response message identifies identifier 450, and therefore, the associated user.

In one embodiment, transmitter 410 periodically transmits a signal. If receiver 420 receives the response message from transceiver 460, control circuit 430 causes electronic system 400 to remain in a normal operating mode.

In one embodiment, if receiver 420 does not receive a message from transceiver 460 within a predetermined period of time of a previous message, receiver 420 generates a signal to control circuit 430 indicating that identifier 450 is not within the predetermined proximity of electronic system 400.

When control circuit 430 receives the signal form receiver 420 that identifier 450 is not within the predetermined proximity of electronic device 400, control circuit 430 causes electronic system 400 to change states. For example, control circuit 430 can cause electronic device 400 to enter a low power state, to enter a secure state in which access is denied to unauthorized users, or to shut down.

In one embodiment, if electronic system 400 is in a low power state, in a secure state or shut down and receiver 420 receives a signal from transceiver 460 that indicating that identifier 450 is within the predetermined proximity, control circuit 430 can cause electronic system 400 to exit the low power state, exit the secure state, or boot up. Thus, control circuit 430 can cause electronic system 400 to enter an operating mode without requiring interaction from the user.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. An electronic device comprising:
a detection circuit to detect whether a predetermined device is within a predetermined proximity of the electronic device; and
a control circuit to cause the electronic device to be in a first state when the predetermined device is within the predetermined proximity and to cause the electronic device to be in a second state when the predetermined device is not within the predetermined proximity.

2. The electronic device of claim 1 wherein the first state comprises a normal operating state.

3. The electronic device of claim 2 wherein the second state comprises a lower power state.

4. The electronic device of claim 2 wherein the second state comprises a locked state to deny access to the electronic device when the electronic device is in the second state.

5. The electronic device of claim 1 wherein the predetermined device comprises a transmitter to transmit wireless signals and the detector comprises a receiver to receive the wireless signals from the predetermined device.

6. The electronic device of claim 1 further comprising a transmitter to transmit wireless signals to the predetermined device, wherein the predetermined device comprises a reflective device to reflect the wireless signals to the detection circuit.

7. An identification device comprising a transmitter to transmit wireless signals to an electronic device, the wireless signals to identify the identification device to the electronic device, the wireless signals further to be used by the electronic device to determine whether the identification device is within a predetermined proximity to the electronic device such that the electronic device is in a first state when the identification device is within the predetermined proximity and the electronic device is in a second state when the identification device is not within the predetermined proximity.

8. The identification device of claim 7 wherein the first state comprises a normal operating state.

9. The identification device of claim 8 wherein the second state comprises a lower power state.

10. The identification device of claim 8 wherein the second state comprises a locked state to deny access to the electronic device when the electronic device is in the second state.

11. A method comprising:
determining whether a predetermined device is within a predetermined proximity of an electronic device;
causing the electronic device to be in a first state when the predetermined device is within the predetermined proximity of the electronic device; and
causing the electronic device to be in a second state when the predetermined device is not within the predetermined proximity of the electronic device.

12. The method of claim 11 wherein the first state comprises a normal operating state.

13. The method of claim 12 wherein the second state comprises a lower power state.

14. The method of claim 12 wherein the second state comprises a locked state to deny access to the electronic device when the electronic device is in the second state.

15. The method of claim 11 wherein determining whether the predetermined device is within the predetermined proximity to the electronic device further comprises:
transmitting a wireless signal;
detecting whether the wireless signal is reflected by the predetermined device;
determining, from the reflected signal, whether the predetermined device is within the predetermined proximity to the electronic device.

16. The method of claim 11 wherein determining whether the predetermined device is within the predetermined proximity to the electronic device further comprises:
transmitting a wireless signal;
detecting whether an acknowledge signal is transmitted by the predetermined device in response to the wireless signal; and
determining, from the acknowledge signal, whether the predetermined device is within the predetermined proximity to the electronic device.

17. The method of claim 11 wherein determining whether the predetermined device is within the predetermined proximity to the electronic device further comprises:
detecting a signal transmitted by the predetermined device; and
determining, from the signal, whether the predetermined device is within the predetermined proximity to the electronic device.

18. An article comprising a machine-accessible medium providing access to sequences of instructions that, when executed by one or more processors, cause the one or more processors to:
determine whether a predetermined device is within a predetermined proximity of an electronic device;
cause the electronic device to be in a first state when the predetermined device is within the predetermined proximity of the electronic device; and
cause the electronic device to be in a second state when the predetermined device is not within the predetermined proximity of the electronic device.

19. The article of claim 18 wherein the first state comprises a normal operating state.

20. The article of claim 19 wherein the second state comprises a lower power state.

21. The article of claim 19 wherein the second state comprises a locked state to deny access to the electronic device when the electronic device is in the second state.

22. The article of claim 18 wherein the sequences of instructions that cause the one or more processors to determine whether the predetermined device is within the predetermined proximity to the electronic device further comprises sequences of instructions that, when executed, cause the one or more processors to:
transmit a wireless signal;
detect whether the wireless signal is reflected by the predetermined device;
determine, from the reflected signal, whether the predetermined device is within the predetermined proximity to the electronic device.

23. The article of claim 18 wherein the sequences of instructions that cause the one or more processors to determine whether the predetermined device is within the predetermined proximity to the electronic device further comprises sequences of instructions that, when executed, cause the one or more processors to:
transmit a wireless signal;
detect whether an acknowledge signal is transmitted by the predetermined device in response to the wireless signal; and
determine, from the acknowledge signal, whether the predetermined device is within the predetermined proximity to the electronic device.

24. The article of claim 18 wherein the sequences of instructions that cause the one or more processors to determine whether the predetermined device is within the predetermined proximity to the electronic device further comprises sequences of instructions that, when executed, cause the one or more processors to:
detect a signal transmitted by the predetermined device; and
determine, from the signal, whether the predetermined device is within the predetermined proximity to the electronic device.

25. A method comprising:
detecting when a predetermined device enters a predetermined region with respect to an electronic device; and
causing the electronic device to boot up in response to the predetermined device entering the predetermined region.

26. The method of claim 25 wherein determining when the predetermined device enters the predetermined region with respect to the electronic device further comprises:
transmitting a wireless signal;
detecting whether the wireless signal is reflected by the predetermined device;
determining, from the reflected signal, whether the predetermined device is within the predetermined region with respect to the electronic device.

27. The method of claim 25 wherein determining when the predetermined device enters the predetermined region with respect to the electronic device further comprises:
transmitting a wireless signal;
detecting whether an acknowledge signal is transmitted by the predetermined device in response to the wireless signal; and
determining, from the acknowledge signal, whether the predetermined device is within the predetermined region with respect to the electronic device.

28. The method of claim 25 wherein determining when the predetermined device enters the predetermined region with respect to the electronic device further comprises:
detecting a signal transmitted by the predetermined device; and
determining, from the signal, whether the predetermined device is within the predetermined region to the electronic device.

29. An article comprising a machine-accessible medium to provide access to sequences of instructions that, when executed, cause one or more electronic devices to:
detect when a predetermined device enters a predetermined region with respect to at least one of the one or more electronic device; and
cause the electronic device to boot up in response to the predetermined device entering the predetermined region.

30. The article of claim 25 wherein the sequences of instructions that cause the one or more electronic devices to determine when the predetermined device enters the predetermined region with respect to the electronic device further comprises sequences of instructions that, when executed, cause the one or more electronic devices to:
transmit a wireless signal;
detect whether the wireless signal is reflected by the predetermined device;
determine, from the reflected signal, whether the predetermined device is within the predetermined region with respect to the electronic device.

31. The article of claim 25 wherein the sequences of instructions that cause the one or more electronic devices to determine when the predetermined device enters the predetermined region with respect to the electronic device further comprises sequences of instructions that, when executed, cause the one or more electronic devices to:
transmit a wireless signal;
detect whether an acknowledge signal is transmitted by the predetermined device in response to the wireless signal; and
determine, from the acknowledge signal, whether the predetermined device is within the predetermined region with respect to the electronic device.

32. The article of claim 25 wherein the sequences of instructions that cause the one or more electronic devices to determine when the predetermined device enters the predetermined region with respect to the electronic device further comprises sequences of instructions that, when executed, cause the one or more electronic devices to:
detect a signal transmitted by the predetermined device; and
determine, from the signal, whether the predetermined device is within the predetermined region to the electronic device.

33. An electronic device comprising:
a detector that detects when a predetermined device is within a predetermined range of the electronic device; and
a control circuit that causes the electronic device to boot up in response to the predetermined device entering the predetermined range.

34. The electronic device of claim 33 wherein the predetermined device comprises a transmitter to transmit wireless signals and the detector comprises a receiver to receive the wireless signals from the predetermined device.

35. The electronic device of claim 33 further comprising a transmitter to transmit wireless signals to the predetermined device, wherein the predetermined device comprises a reflective device to reflect the wireless signals to the detection circuit.
